(19) United States
(12) Patent Application Publication
(10) Pub. No.: US 2007/0271140 A1
(43) Pub. Date: Nov. 22, 2007

(54) Electronic Advertisement Management Apparatus, Electronic Advertisement Client Apparatus, Computer Readable Medium, And Electronic Advertisement System

(75) Inventor: Eisuke Kanno, Kanagawa (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 11/560,468

(22) Filed: Nov. 16, 2006

(30) Foreign Application Priority Data
May 17, 2006 (JP) 2006-137518

(51) Int. Cl. G06Q 30/00

(52) U.S. Cl. 705/14

(57) ABSTRACT

There is provided an electronic advertisement management apparatus including a reservation time management table that stores a reserved communication time for each of a plurality of electronic advertisement client apparatus, a reservation time determination unit that determines a reserved communication time with the electronic advertisement client apparatus by reference to the reservation time management table, a reservation registration unit that gives a notice of the reserved communication time determined by the reservation time determination unit to the electronic advertisement client apparatus and registers the reserved communication time in the reservation time management table, and a client management unit that executes at least one of provision of program schedule data to the electronic advertisement client apparatus and acquisition of operation record data from the electronic advertisement client apparatus in response to access from the electronic advertisement client apparatus.

### BACKGROUND

1. Priority Information

This application claims priority from Japanese Patent Application No. 2006-137518, filed on May 17, 2006.

2. Technical Field

The present invention relates to a technique for providing commercial or non-commercial advertisement content to a client apparatus via a network and displaying the same.

2. Related Art

There has conventionally been known a system that transmits content data (hereinafter referred to as “content”) for giving notice of a commercial advertisement and non-commercial information to a client apparatus via a network such as the Internet and that displays and outputs the same.

### SUMMARY

According to an aspect of the invention, there is provided an electronic advertisement management apparatus including a reservation time management table that stores a reserved communication time for each electronic advertisement client apparatuses, a reservation time determination unit that determines a reserved communication time with the electronic advertisement client apparatus by reference to the reservation time management table, a reservation registration unit that gives a notice of the reserved communication time determined by the reservation time determining unit to the electronic advertisement client apparatus and registers the reserved communication time to the reservation time management table, and a client management unit that executes at least one of provision of program schedule data to the electronic advertisement client apparatus and acquisition of operation record data from the electronic advertisement client apparatus in response to access from the electronic advertisement client apparatus.

### BRIEF DESCRIPTION OF THE DRAWINGS

An embodiment of the present invention will be described in detail by reference to the following figures, wherein:

FIG. 1 illustrates a schematic structure of an electronic advertisement system;

FIG. 2 illustrates an example of a reservation time table to be managed by an electronic advertisement server;

FIG. 3 illustrates an example of data possessed by a schedule database of the electronic advertisement server;

FIG. 4 illustrates an example of data to be stored in an operation record storage;

FIG. 5 illustrates a typical appearance of an example of an electronic poster apparatus;

FIG. 6 illustrates an example of a processing procedure for a reservation for communication of an access controller;

FIG. 7 illustrates an example of another procedure for the reservation for communication of the access controller; and

FIG. 8 illustrates an example of a hardware structure of a computer.

### DETAILED DESCRIPTION

An exemplary embodiment of an electronic advertisement system according to the invention will be described below with reference to the drawings. An “advertisement” encompasses both commercial and non-commercial advertisements and generally indicates broadcasting information to people. An electronic advertisement uses advertisement content expressed in electronic data. The advertisement content can include various elements; for example, text, graphics, images, animation, a voice, or a structural document containing the various elements.

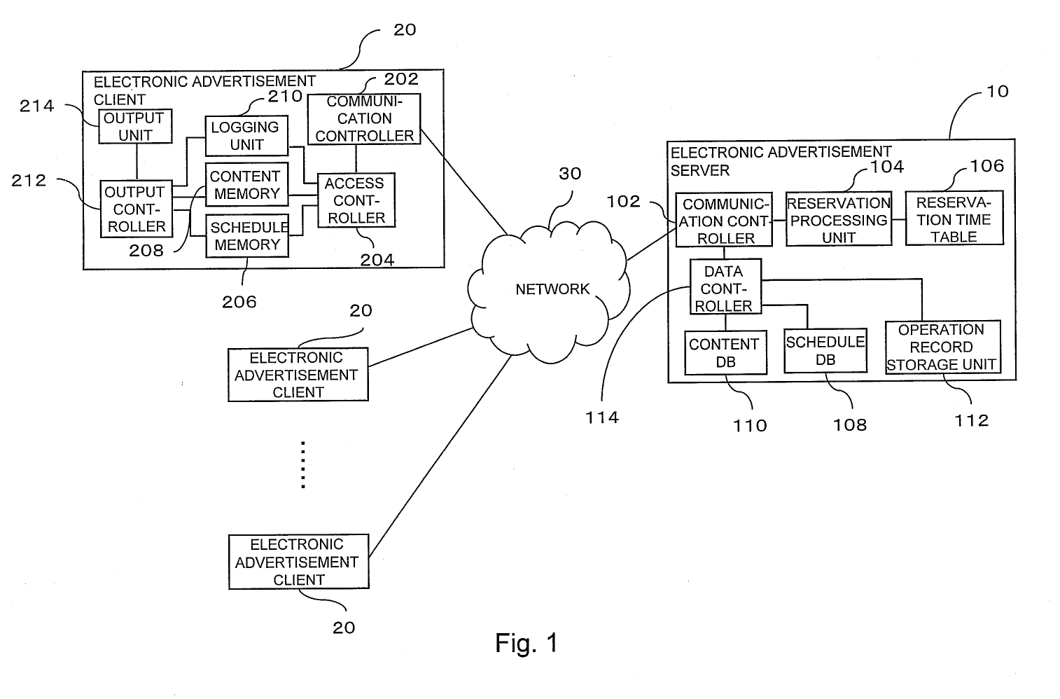

FIG. 1 shows a schematic structure of the electronic advertisement system according to the exemplary embodiment. The electronic advertisement system includes an electronic advertisement server 10 and an electronic advertisement client 20 that are connected to each other through a data communication network 30 such as the Internet.

The electronic advertisement server 10 serves to manage the electronic advertisement client 20, and executes a process for providing program schedule data to the electronic advertisement client 20 and a process for receiving and storing operation record data (log data) from the electronic advertisement client 20.

The program schedule data indicates a set of advertisement content lists to be displayed and output by the electronic advertisement client 20, and furthermore, may include information about the output sequence of the advertisement content contained in the set or may include information about a display time for each advertisement content in the set. The electronic advertisement server 10 may provide, to the electronic advertisement client 20, each advertisement content indicated by program schedule data together with the schedule data. Moreover, the operation record data are obtained by recording various events that occur in a period in which the electronic advertisement client 20 is operated to display and output an advertisement.

The electronic advertisement server 10 manages multiple electronic advertisement clients 20. Although FIG. 1 shows one electronic advertisement server 10, multiple electronic advertisement servers 10 may be present on the network 30.

The electronic advertisement client 20 is an apparatus for displaying and outputting advertisement contents. The electronic advertisement client 20 may be a dedicated advertisement apparatus such as a so-called electronic signboard apparatus or electronic poster apparatus or may be a program to be operated over an OS (operating system) such as Windows (registered trademark). In the latter case, a computer executing the program fulfills the function of the electronic advertisement client 20. The electronic advertisement client 20 typically displays the advertisement contents on a display such as a liquid crystal display or a plasma display. Moreover, the electronic advertisement client 20 may have the function of outputting a voice corresponding to the display. Furthermore, the electronic advertisement client 20 may include a printer for printing and outputting the advertisement contents.

The electronic advertisement client 20 is not restricted to a type for displaying the advertisement contents on the display. The electronic advertisement client 20 may be an apparatus for printing and outputting the advertisement contents or may be an apparatus for transmitting the advertisement contents to a pre-registered destination in facsimile.

Next, the electronic advertisement server 10 will be described in more detail. As shown in FIG. 1, the electronic advertisement server 10 includes a communication controller 102, a reservation processing unit 104, a reservation time table 106, a schedule DB (database) 108, a content DB 110, an operation record storage unit 112, and a data controller 114.

The communication controller 102 controls data communication with the electronic advertisement client 20 through the network 30. The reservation processing unit 104 carries out a process for reserving a time at which data communication is to be carried out together with the electronic advertisement client 20 in response to a request for a reservation that is received from the electronic advertisement client 20. Such a time will be referred to as a reserved communication time. The reserved communication time determined by the reservation process unit 104 is registered in the reservation time table 106.

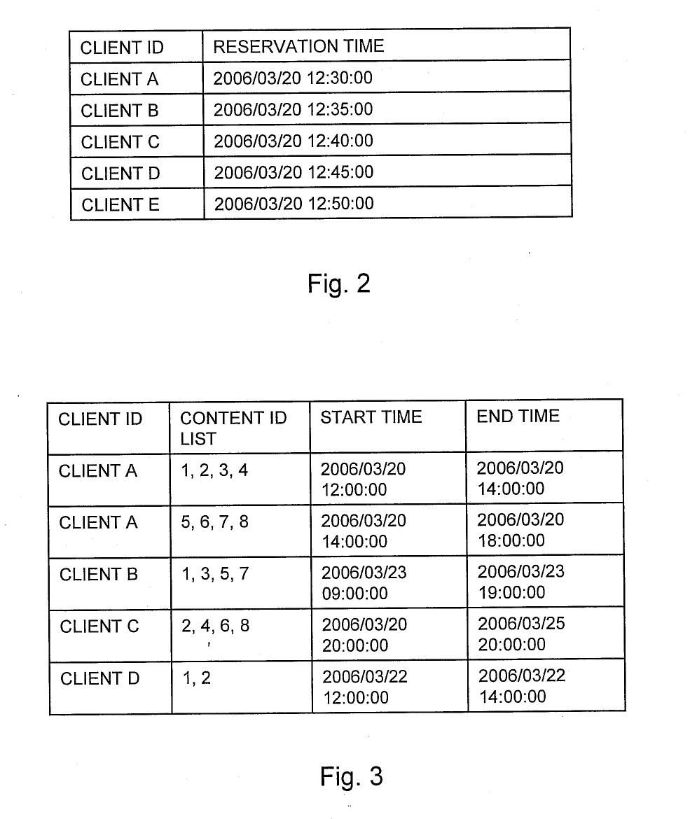

An example of the reservation time table 106 will be described with reference to FIG. 2. As shown in FIG. 2, identification information (a client ID) of the client 20 and a reserved communication time are registered in the reservation time table 106 for every electronic advertisement client 20 to be managed by the electronic advertisement server 10. It is possible to employ any client ID that can uniquely identify the electronic advertisement client 20, and an IP (Internet Protocol) address and a MAC (Media Access Control) address of the electronic advertisement client 20 may be used as the client ID. FIG. 2 shows an example of the case in which the electronic advertisement server 10 manages five electronic advertisement clients 20 (A to E), and one reserved communication time (or a date) is registered for each electronic advertisement client 20. This illustrates an example of the case in which only a reservation time for the next communication operation to each electronic advertisement client 20 is registered in the reservation time table 106. In this example, the reserved communication times of the respective clients 20 are set at intervals of five minutes. However, the interval of five minutes is a value determined with a margin in such a manner that multiple clients 20 do not make access to the server 10 at the same time, in consideration of a mean time required for one data communication operation between the server 10 and one of the clients 20. As a matter of course, a numeric value of five minutes is only illustrative.

Program schedule data provided by the electronic advertisement client 20 are registered in the schedule DB (database) 108. FIG. 3 shows an example of data possessed by the schedule DB 108. In a table shown in FIG. 3, one row indicates one record of program schedule data. One record of program schedule data include items such as a client ID, a content ID list, a start time, and an end time. The client ID is identification information about the client 20 to which the program schedule data are to be provided. The content ID list includes identification information (a content ID) about advertisement content (that is, a program) to be displayed and output to the client 20. Sequence of arrangement of the content ID in the list may represent sequence of the display and output of the advertisement contents. The start time and the end time indicate date and time of the start and end of an output period for which contents shown in the content ID list are displayed and output, respectively. Each advertisement content is repetitively displayed and output in accordance with output sequence for the output period. For example, program schedule data in the lowest row of a table in FIG. 3 indicate that contents having content IDs of 1 and 2 are repetitively output from 12:00:00 on Mar. 22, 2006 to 14:00:00. The program schedule data may include a length of a display time for each advertisement content in the list per cycle. Moreover, it is also possible to incorporate information about a default value of a display time per cycle into the program schedule data in the case where such individual display times are not specified. For example, incase of still picture content such as a text document, it is possible to switch a display into a next content every display time.

The advertisement content is registered in the content DB 110 corresponding to the content ID. The content ID included in the program schedule data is identification information about the advertisement content in the content DB 110.

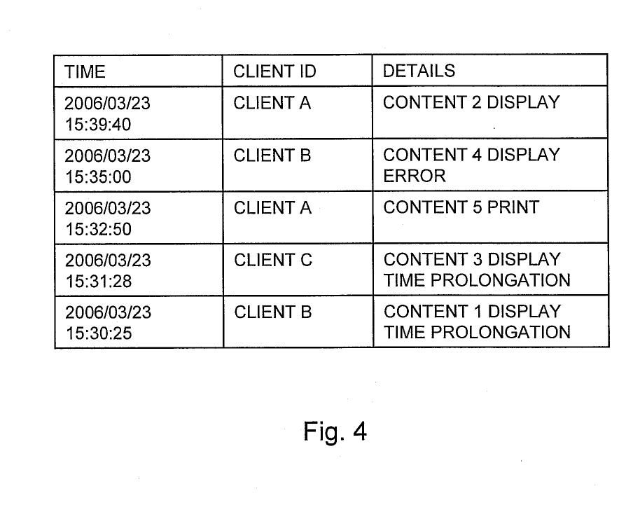

Operation record data transmitted from each electronic advertisement client 20 are stored in the operation record storage unit 112. FIG. 4 shows an example of data stored in the operation record storage unit 112. As shown in this example, individual log records stored in the operation record storage unit 112 include a time at which an event occurs, a client ID of the electronic advertisement client 20 in which the event occurs, and event detail information indicative of the details of the event. For example, a first record shown in the drawing indicates an event in which display of content 2 (content having a content ID of “2”) in a client A is started at 15:39:40 on Mar. 23, 2006.

The data controller 114 is a functional module for controlling reading/writing of data to each of the databases 108 and 110 and the operation record storage unit 112 in response to a request sent from the electronic advertisement client 20. In the case where the program schedule data are required from the client 20, the data controller 114 fetches from the schedule DB 108 the program schedule data having the client ID of the client 20. For instance, according to an example, there are provided program schedule data having an output period corresponding to a time at which the request is received in at least one set of program schedule data corresponding to the client 20 serving as a request source.

Next, description will be given to the details of the electronic advertisement client 20. As shown in FIG. 1, the electronic advertisement client 20 includes a communication controller 202, an access controller 204, a schedule memory 206, a content memory 208, a logging unit 210, an output controller 212, and an output unit 214.

The communication controller 202 controls data communication with the electronic advertisement server 10 via the network 30. The access controller 204 controls transmission of a request to the electronic advertisement server 10 and transfer of various data. A process to be executed by the access controller 204 will be described below in detail. The schedule memory 206 stores program schedule data acquired from the electronic advertisement server 10. The content memory 208 stores data on advertisement contents acquired from the electronic advertisement server 10.

The logging unit 210 monitors various events that occurs in the electronic advertisement client 20 and creates and stores a log record (operation record data) of the event. The log record includes a time at which the event occurs and event detail information indicative of the details of the event. For instance, there are events such as a display of the advertisement content, an operation carried out by a user (a print or a display time prolongation) and a failure of the client 20 (for example, a failure of a content display).

Moreover, a snapshot image of the advertisement content actually displayed in the event may be recorded as information related to the log record of the content display event. The snapshot image may be a displayed image (a bit map) itself or an image obtained by thinning or compression. In any case, there is required such a resolution that any content that is displayed can be confirmed later. For this reason, a data volume of the snapshot image is apt to be increased to some extent. Moreover, the number of snapshot images transmitted to the electronic advertisement server 10 by the electronic advertisement client 20 in one access operation is increased to some extent. For this reason, a load for communication and a load for storing the received data are increased in the electronic advertisement server 10. Therefore, a significant task is to avoid congestion of the transmission of the snapshot image from a large number of electronic advertisement clients 20 to the electronic advertisement server 10.

The output unit 214 is a device for displaying and outputting advertisement contents and may be a display, a speaker, a printer, a facsimile device, or a combination thereof. The output controller 212 controls output of the advertisement contents from the output unit 214. More specifically, the output controller 212 refers to the program schedule data stored in the schedule memory 206, fetches, in sequence, contents having the respective content IDs shown in the content ID list from the content memory 208, and transfers and outputs the contents to the output unit 214. In the case where a display time for each content per cycle is determined, the output unit 214 is caused to output the content for the display time. When the display time passes, the next content is output.

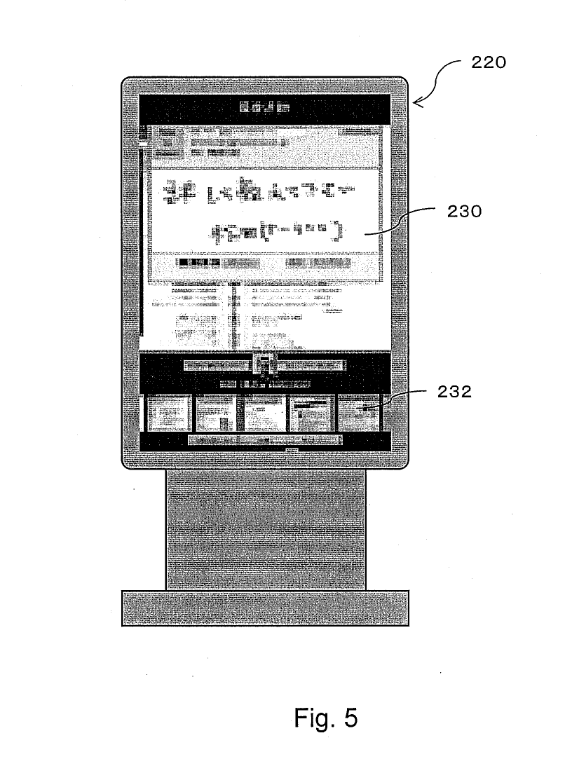

As an example of the electronic advertisement client 20, FIG. 5 shows an example of a dedicated electronic poster apparatus. In this example, an advertisement content to be output is displayed on a main screen unit 230 of a display 220 in the electronic poster apparatus, and furthermore, a thumbnail image 232 of each advertisement content included in the content ID list of the program schedule data is displayed in a region that is adjacent to the main screen unit 230. In principle, contents indicated in the program schedule data are output in accordance with the sequence shown in the program schedule data. A user finds a content that he (she) wants to see from the thumbnail images 232 and the user touches the thumbnail images 232, a result of the selection is transmitted to the output controller 212 by a touch panel function of the display 220, and the output controller 212 reads the selected content from the content memory 208 and causes the output unit 214 to output the content. Moreover, icons for various operations such as “print” and “display time prolongation” are displayed on the display 220, and the user can also indicate various operations for the content displayed in the main screen unit 230 by touching the icon. For example, when the user touches a “print” button, the advertisement content that is being displayed and output is printed and output from the printer connected to the electronic poster apparatus. When the user touches a “display time prolongation” button, moreover, the display time of the advertisement content that is being displayed is prolonged. In the case where link information about a hypertext is incorporated in the advertisement content, moreover, the apparatus can also make access to a link destination to download and output the content when the user touches the display of the link.

Next, description will be given to a process to be executed by the system according to the exemplary embodiment.

When the electronic advertisement client 20 is turned ON, the access controller 204 makes access to the electronic advertisement server 10 and a pertinent entry of the program schedule data for the electronic advertisement client 20 at that time is downloaded and stored in the schedule memory 206. Moreover, substantial data of each content included in the list of the schedule at this time may be acquired from the electronic advertisement server 10 and stored in the content memory 208. It is also possible to download the substantial data of the content described on the schedule when the turn for the output comes every content without first downloading the substantial data of the contents on the schedule collectively. The output controller 212 outputs the advertisement content from the output unit 214 in sequence in accordance with the program schedule data that are acquired at this time, and the logging unit 210 records an event that occurs in the client 20 for that time. In a flow of the process, moreover, the access controller 204 gives a request for a reservation of next communication to the electronic advertisement server 10 in access given at power-ON.

Upon receiving the reservation, the electronic advertisement server 10 refers to the reservation time table 106 and selects, for example, the earliest time in an unallocated time of the server 10 as a reserved communication time with the client 20 which is a request source, and gives a notice of the selection to the client 20 and registers the selection in the reservation time table 106. The reserved communication time may be set at an interval anticipating a slight margin in such a manner that the clients 20 do not make access to the server 10 at the same time. Accordingly, the reserved communication time may be grasped to represent a period during which communication is carried out (a time slot). Therefore, it is preferable to grasp the unallocated time as an unselected time slot. In the case where the server 10 has a capability for communicating with multiple clients 20 at the same time, the reserved communication time may be set in correspondence to a number within the capability of the server 10 at the same time.

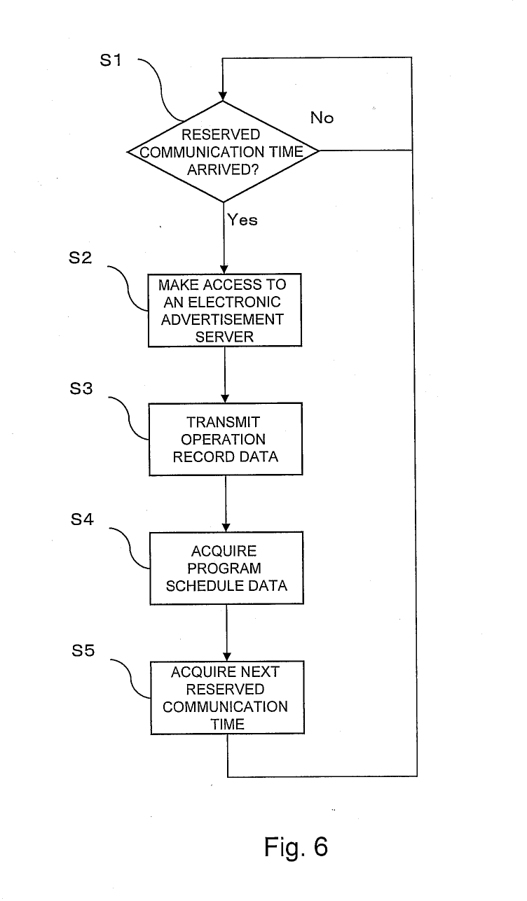

The access controller 204 stores the reserved communication time acquired from the electronic advertisement server 10 and executes a process shown in FIG. 6. In this process, the access controller 204 periodically determines whether or not the reserved communication time has arrived (S1), makes access to the electronic advertisement server 10 by using the communication controller 202 if the reserved communication time has arrived (S2), and fetches operation record data (log records) from the logging unit 210 and sends the same data to the electronic advertisement server 10 (S3). The electronic advertisement server 10 registers the received operation record data in the operation record storage unit 112 corresponding to an ID of the client 20 which is a transmission source and sorts the registered operation record data in sequence of generation time. The operation record data transmitted from the electronic advertisement client 20 to the electronic advertisement server 10 may be deleted from the logging unit 210 or may leave the transmitted record so as not to transmit the data next time.

Moreover, the access controller 204 issues a request for the program schedule data to the electronic advertisement server 10 (S4). In response to the request, the electronic advertisement server 10 reads the program schedule data of the client 20 from the schedule DB 108 at that time and provides the program schedule data to the client 20. At this time, the substantial data of the content described on the schedule may also be provided to the client 20. In the case where the reserved communication time is earlier than an “end time” of an output period of a program indicated by the program schedule data, there is a possibility that the client 20 might acquire in Step S4 the same data as the held program schedule data. In consideration of the case where a change is applied to the program schedule data for the output period of a program, however, it is possible to acquire the program schedule data after the change and to follow the change by repetitively re-acquiring the program schedule data for the output period.

Moreover, the access controller 204 carries out a reservation for next communication over the electronic advertisement server 10 (S5). In response to the request for the reservation, the electronic advertisement server 10 refers to the reservation time table 106 to select, as a reserved communication time, a time (an unallocated time) at which the server 10 can carry out communication, thereby giving a notice to the client 20 and registering the same time in the reservation time table 106. If the earliest time in the unallocated time is selected at this time, it is possible to increase the number of acquisitions of the program schedule data for the output period of the program, thereby enhancing follow ability to the change of the program schedule.

The process is repeated while the electronic advertisement client 20 is operated. Steps S3, S4, and S5 may be executed in arbitrary sequence.

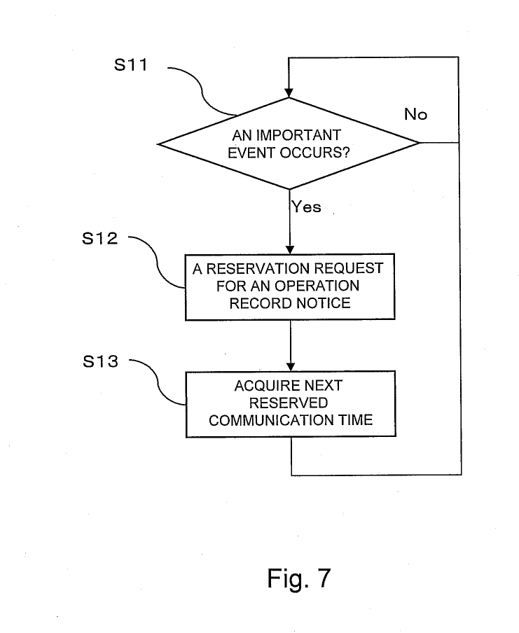

While the transmission of the operation record data and the acquisition of the program schedule data are executed at the same reserved communication time in the procedure of FIG. 6, this is not indispensable. As a matter of course, reserved communication times for the former and latter cases can be set separately. In particular, there may be of a serious failure that is preferably reported as early as possible to the electronic advertisement server 10 side. It is also possible to propose that a reservation for communication can be given to the electronic advertisement server 10 at the time when the electronic advertisement client 20 detects the failure and a reservation request can be given to the server 10 as early as possible. The procedure is shown in FIG. 7.

In this example, the logging unit 210 of the electronic advertisement client 20 registers a type of an event of which the electronic advertisement server 10 is to be notified in the early stage. For example, there are the case where a specific type of error occurs and the case where a user carries out a specific type of operation. In the case where the logging unit 210 detects the occurrence of the event that is registered (S11), the access controller 204 reserves communication for a notice of the operation record for the electronic advertisement server 10 (S12) Correspondingly, the electronic advertisement server 10 detects an unallocated time of the reservation time table 106 and selects the time as a reserved communication time, and gives a notice to the client 20. The access controller 204 of the client 20 receiving the notice stores the reserved communication time (S13) When the time arrives, untransmitted operation record data that are recorded in the logging unit 210 at that time are transmitted to the electronic advertisement server 10.

In the case where the unallocated time detected at a request in Step S12 is later than a next reserved communication time that has already been assigned to the electronic advertisement client 20 that is a request source, the electronic advertisement server 10 may return a code indicating that the reserved communication time that has already been assigned is effective, without setting the unallocated time to be the reserved communication time.

Moreover, it is also possible to periodically reserve a time slot for giving a notice of the event in a series of time slots. A time slot for a notice of the event is selected only in the case where the event occurs, and the same time slot is not selected for a normal reservation for communication in accordance with the procedure of FIG. 6.

Although in the present example the substantial data of the advertisement content are provided from the electronic advertisement server 10 to the electronic advertisement client 20, this is not indispensable. It is also possible to distribute and dispose the substantial data of the advertisement contents to a large number of servers on the network 30 and to provide address information about the advertisement contents (for example, URLs (Uniform Resource Locators)) from the electronic advertisement server 10 to the electronic advertisement client 20. Every time the substantial data of the advertisement content are required, the electronic advertisement client 20 uses address information thereof, thereby giving access to a server having the substantial data and acquiring the data.

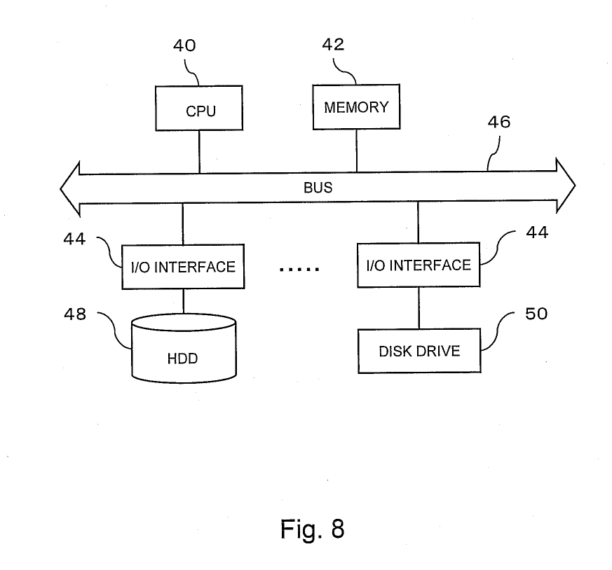

The above-described electronic advertisement server 10 is typically implemented by executing, on a general-purpose computer, a program describing the functions or processing of the above-described components. For hardware, as shown in FIG. 8, the computer has circuitry in which components such as a CPU (Central Processing Unit) 40, memory (primary storage) 42, and various I/O (input/output) interfaces 44 are connected with each other via a bus 46. For example, a hard disk drive 48 and a disk drive 50 for reading removable nonvolatile recording media of various standards, such as CDs, DVDs, and flash memory, are connected to the bus 46, via the I/O interfaces 44. These drives 48 and 50 function as external storage devices for the memory. The program describing the processing of the electronic advertisement server 10 of the exemplary embodiment is stored in a secondary storage device such as the hard disk drive 48 via a recording medium such as a CD or DVD, or over a network, and installed on the computer. The program stored in the secondary storage device is read out to the memory and executed by the CPU, thereby implementing the processing of the exemplary embodiment. Similarly, the electronic advertisement client 20 may be implemented with an architecture similar to that of the general-purpose computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

1. An electronic advertisement management apparatus comprising:
a reservation time management table that stores a reserved communication time for each of a plurality of electronic advertisement client apparatus;
a reservation time determination unit that determines a reserved communication time with the electronic advertisement client apparatus by reference to the reservation time management table;
a reservation registration unit that gives a notice of the reserved communication time determined by the reservation time determination unit to the electronic advertisement client apparatus and registers the reserved communication time in the reservation time management table; and
a client management unit that executes at least one of provision of program schedule data to the electronic advertisement client apparatus and acquisition of operation record data from the electronic advertisement client apparatus in response to access from the electronic advertisement client apparatus.

2. The electronic advertisement management apparatus according to claim 1, wherein the reservation time determination unit determines a reserved communication time with the electronic advertisement client apparatus when a reservation request is received from the electronic advertisement client apparatus.

3. The electronic advertisement management apparatus according to claim 2, wherein the reservation request includes a first reservation request for communication of the operation record data and a second reservation request for communication of the program schedule data, and
the reservation time determination unit determines a reserved communication time that serves to acquire operation record data when receiving the first reservation request from the electronic advertisement client apparatus, and determines a reserved communication time that serves to provide program schedule data when receiving the second reservation request from the electronic advertisement client apparatus.

4. The electronic advertisement management apparatus according to claim 1, further comprising a schedule database holding program schedule data for every time period, and wherein
when receiving access to acquire the program schedule data from the electronic advertisement client apparatus, the client management unit provides, from the schedule database, program schedule data for an effective time period at that time.

5. A computer readable medium storing a program for causing a computer to execute a process for electronic advertisement management, the process comprising:
storing a reserved communication time for each of a plurality of electronic advertisement client apparatus;
determining a reserved communication time with an electronic advertisement client apparatus by reference to a reservation time management table;
giving a notice of the determined reserved communication time to the electronic advertisement client apparatus and registering the reserved communication time in the reservation time management table; and
executing at least one of provision of program schedule data to the electronic advertisement client apparatus and acquisition of operation record data from the electronic advertisement client apparatus in response to access from the electronic advertisement client apparatus.

6. The medium according to claim 5, wherein determining the reserved communication time includes:
determining a reserved communication time with the electronic advertisement client apparatus when receiving a reservation request from the electronic advertisement client apparatus.

7. The medium according to claim 6, wherein the reservation request has a first reservation request for communication with the operation record data and a second reservation request for communication with the program schedule data, and
determining the reserved communication time includes:
determining a reserved communication time for acquiring the operation record data when receiving the first reservation request from the electronic advertisement client apparatus; and
determining a reserved communication time for providing the program schedule data when receiving the second reservation request from the electronic advertisement client apparatus.

8. The medium according to claim 5, wherein executing at least one of provision of program schedule data to the electronic advertisement client apparatus and acquisition of operation record data from the electronic advertisement client apparatus includes:
when access for acquiring the program schedule data is received from the electronic advertisement client apparatus, providing the program schedule data for an effective time period at that time from a schedule database holding program schedule data for each time period.

9. An electronic advertisement client apparatus comprising:
a content display management unit that displays advertisement contents in accordance with program schedule data acquired from an electronic advertisement management apparatus;
a reservation time memory that stores a reserved communication time notified from the electronic advertisement management apparatus; and
a schedule acquisition unit that accesses to the electronic advertisement management apparatus and acquires the program schedule data at the reserved communication time stored in the reservation time memory.

10. The electronic advertisement client apparatus according to claim 9, wherein the schedule acquisition unit acquires a next reserved communication time from the electronic advertisement management apparatus and registers the acquired next reserved communication time in the reservation time memory when acquiring the program schedule data.

11. The electronic advertisement client apparatus according to claim 9, further comprising:
a logging unit that monitors an operation of the electronic advertisement client apparatus and records operation record data; and
an operation record notification unit that transmits operation record data to the electronic advertisement management apparatus at the reserved communication time stored in the reservation time memory.

12. The electronic advertisement client apparatus according to claim 11, further comprising:
a notified-event-type memory that stores a type of an event to be notified to the electronic advertisement management apparatus, and wherein
the logging unit acquires, from the electronic advertisement management apparatus, a reserved communication time for transmitting the operation record data when detecting occurrence of an event of a type stored in the notified-event-type memory.

13. A computer readable medium storing a program for causing a computer to execute a process for displaying an electronic advertisement, the process comprising:
displaying advertisement contents in accordance with program schedule data acquired from an electronic advertisement management apparatus;
storing a reserved communication time notified from the electronic advertisement management apparatus in a reservation time memory; and
making access to the electronic advertisement management apparatus and acquiring the program schedule data at the reserved communication time stored in the reservation time memory.

14. The medium according to claim 13, wherein acquiring the program schedule data includes:
acquiring a next reserved communication time from the electronic advertisement management apparatus and registering the acquired time in the reservation time memory when acquiring the program schedule data.

15. The medium according to claim 13, wherein the process further includes:
monitoring an operation of the electronic advertisement client apparatus and recording operation record data; and
making access to the electronic advertisement management apparatus and transmitting the operation record data at the reserved communication time stored in the reservation time memory.

16. The medium according to claim 15, wherein recording the operation record data further includes:
acquiring, from the electronic advertisement management apparatus, a reserved communication time for transmitting the operation record data when detecting occurrence of an event corresponding to an event type to be notified to the electronic advertisement management apparatus.

17. An electronic advertisement system comprising an electronic advertisement management apparatus and a plurality of electronic advertisement client apparatus,
wherein the electronic advertisement management apparatus includes:
a reservation time management table that stores a reserved communication time for each of a plurality of electronic advertisement client apparatus;
a reservation time determination unit that determines a reserved communication time with the electronic advertisement client apparatus by reference to the reservation time management table;
a reservation registration unit that notifies the electronic advertisement client apparatus of the reserved communication time determined by the reservation time determination unit and registers the same time in the reservation time management table; and
a client management unit that executes at least one of provision of program schedule data to the electronic advertisement client apparatus and acquisition of operation record data from the electronic advertisement client apparatus in response to access from the electronic advertisement client apparatus, and
the electronic advertisement client apparatus includes:
a reservation time memory that stores a reserved communication time notified from the electronic advertisement management apparatus; and
a communication processing unit that makes access to the electronic advertisement management apparatus at the reserved communication time stored in the reservation time memory, and executes acquisition of program schedule data or transmission of operation record data.

18. An electronic advertisement management apparatus comprising:
a reservation time determination unit that determines a reserved communication time for each of a plurality of electronic advertisement client apparatus;
a reservation registration unit that notifies the electronic advertisement client apparatus of the reserved communication time determined by the reservation time determination unit and registers the same time in a reservation time management table; and
a client management unit that executes at least one of provision of program schedule data to the electronic advertisement client apparatus and acquisition of operation record data from the electronic advertisement client apparatus in response to access from the electronic advertisement client apparatus at the reserved communication time.
